(19) United States
(12) Patent Application Publication
(10) Pub. No.: US 2023/0252378 A1
(43) Pub. Date: Aug. 10, 2023

(54) INFORMATION PROCESSING APPARATUS, INFORMATION PROCESSING METHOD, AND INFORMATION PROCESSING PROGRAM

(71) Applicant: Nippon Telegraph and Telephone Corporation, Tokyo (JP)

(72) Inventors: Satoshi TAKATSU, Musashino-shi, Tokyo (JP); Tomoko SHIBATA, Musashino-shi, Tokyo (JP); Hiroshi YOSHIDA, Musashino-shi, Tokyo (JP); Masanobu SAKAMOTO, Musashino-shi, Tokyo (JP)

(21) Appl. No.: 18/008,617

(22) PCT Filed: Jun. 12, 2020
(86) PCT No.: PCT/JP2020/023123

§ 371 Date: Dec. 6, 2022

(51) Int. Cl. G06Q 10/0631

(52) U.S. Cl. CPC G06Q 10/063118

(57) ABSTRACT

An information processing apparatus according to one embodiment includes an assignment cost value list acquisition unit that acquires a first assignment cost value list including an assignment cost value of an individual worker of a plurality of workers for an individual task of a plurality of tasks, a constraint information acquisition unit that acquires information indicating a constraint for an assignment of the individual task, and a constraint reflection unit that generates a second assignment cost value list in accordance with a change of one or more of the assignment cost values including the first assignment cost value list in accordance with the constraint.

### TECHNICAL FIELD

An aspect of the present disclosure relates to an information processing apparatus, an information processing method, and an information processing program.

### BACKGROUND ART

Allocating appropriate workers for a plurality of tasks, such as construction work or product manufacturing, is important from the viewpoint of safety, production efficiency, and the like.

For example, PTL 1 discloses a scheduling method for enabling appropriate allocation of human resources and minimization of a total schedule time by providing a plurality of evaluation criteria in consideration of an individual skill. The plurality of evaluation criteria uses the minimization of the total schedule time, minimization of the number of assigned workers, and minimization of distribution of assigned time for each worker (equality of the assigned time). In addition, an index of the individual skill uses a past record of the processing time taken for each task.

### CITATION LIST

### Patent Literature

PTL 1: JP 2017-211921 A

### SUMMARY OF THE INVENTION

### Technical Problem

Although the scheduling method of PTL 1 assigns tasks on the basis of an assignment cost value, which is an individual skill, PTL 1 discloses no method of creating such an assignment cost value. Thus, the scheduling method of PTL 1 may perform unrealistic assignment of tasks.

The present disclosure has been contrived in view of the above circumstances, and an object of the present disclosure is to provide an information processing apparatus, an information processing method, and an information processing program for providing an assignment cost value to achieve realistic assignment of tasks.

### Means for Solving the Problem

In one aspect of the present disclosure, an information processing apparatus includes an assignment cost value list acquisition unit that acquires a first assignment cost value list including an assignment cost value of an individual worker of a plurality of workers for an individual task of a plurality of tasks, a constraint information acquisition unit that acquires information indicating a constraint for an assignment of the individual task, and a constraint reflection unit that generates a second assignment cost value list in accordance with a change of one or more of the assignment cost values including the first assignment cost value list in accordance with the constraint.

### Effects of the Invention

One aspect of the present disclosure allows for providing an information processing apparatus, an information processing method, and an information processing program for providing an assignment cost value to achieve realistic assignment of tasks.

### BRIEF DESCRIPTION OF DRAWINGS

FIG. 1 is a block diagram illustrating an example of a hardware configuration of an information processing apparatus according to an embodiment of the present disclosure.

FIG. 2 is a block diagram illustrating a software configuration of the information processing apparatus according to the embodiment of the present disclosure.

FIG. 3 is a diagram illustrating an example of a first assignment cost value list according to the embodiment of the present disclosure.

FIG. 4 is a diagram illustrating an example of a worker list according to the embodiment of the present disclosure.

FIG. 5 is a diagram illustrating an example of a task list according to the embodiment of the present disclosure.

FIG. 6 is a flowchart illustrating a processing procedure and a processing content of processing for calculating an assignment table by the information processing apparatus according to the embodiment of the present disclosure.

FIG. 7 is a flowchart illustrating a processing procedure and a processing content of modification processing by the information processing apparatus according to the embodiment of the present disclosure.

FIG. 8 is a diagram illustrating an example of change of assignment cost values according to the embodiment of the present disclosure.

FIG. 9 is a diagram illustrating an example of change of assignment cost values according to the embodiment of the present disclosure.

FIG. 10 is a diagram illustrating an example of change of assignment cost values according to the embodiment of the present disclosure.

FIG. 11 is a diagram illustrating an example of change of assignment cost values according to the embodiment of the present disclosure.

FIG. 12 is a diagram illustrating an example of change of assignment cost values in accordance with a first constraint according to the embodiment of the present disclosure.

FIG. 13 is a diagram illustrating an example of change of assignment cost values in accordance with a second constraint according to the embodiment of the present disclosure.

FIG. 14 is a diagram illustrating an example of change of assignment cost values in accordance with a third constraint according to the embodiment of the present disclosure.

FIG. 15 is a diagram illustrating an example of change of assignment cost values in accordance with a fourth constraint according to the embodiment of the present disclosure.

FIG. 16 is a diagram illustrating an example of change of assignment cost values in accordance with a fifth constraint according to the embodiment of the present disclosure.

FIG. 17 is a diagram illustrating an example of a second assignment cost value list reflecting a sixth constraint according to the embodiment of the present disclosure.

FIG. 18 is a diagram illustrating an example of a plurality of assignment tables calculated by using the second assignment cost value list reflecting the sixth constraint according to the embodiment of the present disclosure.

FIG. 19 is a diagram illustrating an example of an output assignment table according to the embodiment of the present disclosure.

### DESCRIPTION OF EMBODIMENTS

An embodiment according to the present disclosure will be described below with reference to the drawings.

### Configuration Example

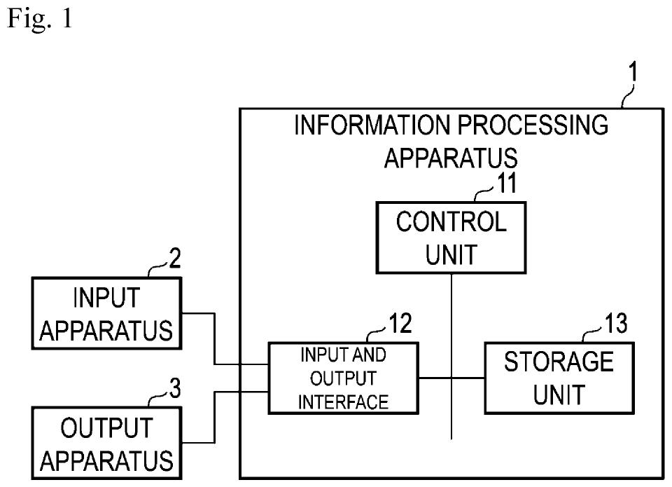

FIG. 1 is a block diagram illustrating an example of a hardware configuration of an information processing apparatus 1 according to the embodiment.

The information processing apparatus 1 is implemented by a computer, such as a personal computer (PC).

The information processing apparatus 1 includes a control unit 11, an input and output interface (I/F) 12, and a storage unit 13. The control unit 11, the input and output I/F 12, and the storage unit 13 are communicably connected to one another via a bus.

The control unit 11 controls the information processing apparatus 1. The control unit 11 includes a hardware processor, such as a central processing unit (CPU).

The input and output I/F 12 is an interface that enables communication with an input apparatus 2 and an output apparatus 3. The input and output I/F 12 may include a wired communication interface and may include a radio communication interface.

The storage unit 13 is a storage medium. For example, the storage unit 13 includes, in combination, a nonvolatile memory capable of writing and reading at any time, such as a hard disk drive (HDD) or a solid state drive (SSD), as a storage medium, a nonvolatile memory, such as a read only memory (ROM), and a volatile memory, such as a random access memory (RAM). The storage unit 13 includes storage areas including a program storage area and a data storage area. The program storage area stores application programs needed to perform various types of processing in addition to middleware such as an operating system (OS).

For example, the input apparatus 2 includes a keyboard, a pointing device, and the like that are used for inputting an instruction into the information processing apparatus 1 by an assigning person (a user) assigning a task to each worker. Additionally, the input apparatus 2 may include a reader used for reading data to be stored in the storage unit 13 from a memory medium such as a USB memory, or a disk device used for reading such data from a disk medium. Furthermore, the input apparatus 2 may include an image scanner including or not including an optical character recognition (OCR) function.

The output apparatus 3 includes a display that displays output data to be presented to the assigning person by the information processing apparatus 1, a printer that prints the output data, and the like. Furthermore, the output apparatus 3 may include a writer for writing data to be input to another information processing apparatus, such as a PC and a smartphone, into a memory medium, such as a USB memory, and a disk device for writing such data to a disk medium.

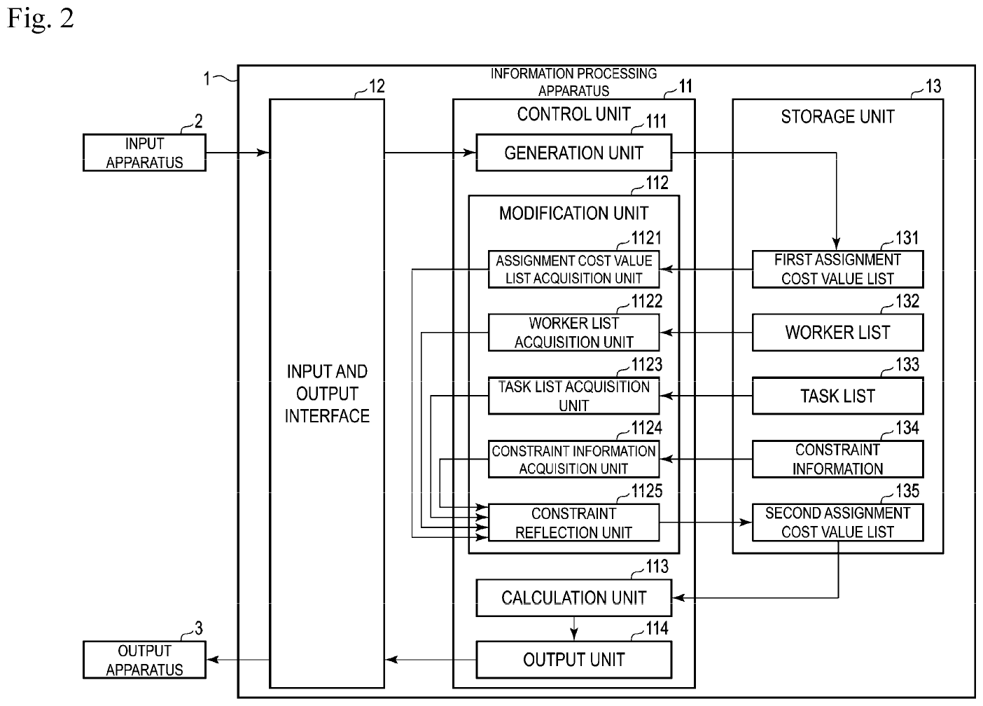

FIG. 2 is a block diagram illustrating a software configuration of the information processing apparatus 1.

Firstly, data stored in the storage unit 13 will be described.

The storage unit 13 stores a first assignment cost value list 131, a worker list 132, a task list 133, constraint information 134, and a second assignment cost value list 135.

The first assignment cost value list 131 is a list including assignment cost values for each of a plurality of tasks by each of a plurality of workers. Each of the assignment cost values is a value expressed as a numerical value set on the basis of any index value of 1 or greater. The assignment cost values are values indicating the suitability of each worker for each task. For example, the index value may include various values of the nationality, a friendship between workers, a quality of contractors, a construction time, a training policy, a business policy, and the like in addition to a skill value according to a past work experience and a difficulty level value of a task. For example, the assignment cost value is a quality value indicating the work quality for each task by each worker, based on the skill value and the difficulty level value. As the assignment cost value increases, the suitability for a task (for example, the quality value) increases. As the assignment cost value increases, the possibility that a task is assigned to the worker increases. It is assumed that the assignment cost value is a value of 1 or greater. For example, the first assignment cost value list 131 may be generated by a generation unit 111 described later and stored in the storage unit 13. Alternatively, the control unit 11 may acquire the first assignment cost value list 131 input through the input apparatus 2, and store the acquired first assignment cost value list 131 into the storage unit 13. The first assignment cost value list 131 may be updated as appropriate. A configuration example of the first assignment cost value list 131 will be described later.

The worker list 132 is a list indicating a classification of a plurality of workers. For example, the worker list 132 indicates a classification in accordance with an attribute of the plurality of workers. For example, the attribute is a proficiency level and the classification is “trainee,” “ordinary,” and “experienced.” It is assumed that the proficiency level increases in the order of “trainee,” “ordinary,” and “experienced.” The classification is not limited to the three levels of “trainee,” “ordinary,” and “experienced,” and may include two levels or four or more levels. The classification names of “trainee,” “ordinary,” and “experienced” are examples, and the classification is not limited to these classification names. In the worker list 132, a classification in accordance with the attribute is associated with each of the plurality of workers. For example, the control unit 11 may acquire the worker list 132 input through the input apparatus 2 and store the acquired worker list 132 into the storage unit 13. The worker list 132 may be updated as appropriate. A configuration example of the worker list 132 will be described later.

The task list 133 is a list indicating a classification of a plurality of tasks. For example, the task list 133 indicates a classification in accordance with an attribute of the plurality of tasks. For example, the attribute is a difficulty level, and the classification is “for training,” “normal,” and “highest level of difficulty.” It is assumed that the difficulty level increases in the order of “for training,” “normal,” and “highest level of difficulty.” The classification is not limited to the three levels of “for training,” “normal,” and “highest level of difficulty” and may include two levels or four or more levels. The classification names of “for training,” “normal,” and “highest level of difficulty” are examples, and the classification is not limited to these classification names. In the task list 133, a classification in accordance with the attribute is associated with each of the plurality of workers. For example, the control unit 11 may acquire the task list 133 input through the input apparatus 2 and store the acquired task list 133 into the storage unit 13. The task list 133 may be updated as appropriate. A configuration example of the task list 133 will be described later.

The constraint information 134 is information indicating a constraint for an assignment of a task. The constraint is a condition for achieving a realistic assignment of tasks. The constraint specifically expresses the thoughts of the assigning person. Examples of the thoughts of the assigning person include a desire to entrust only an experienced worker with a task having the highest level of difficulty for safety reasons, a desire to always keep the number of tasks assigned to a trainee at a constant number (for example, always keep the number of tasks assigned to a trainee at one task), a desire to help the trainee gain an experience, and a desire to automate an assignment also when a task is done by a plurality of workers. The control unit 11 may acquire the constraint information 134 input through the input apparatus 2 and store the acquired constraint information 134 into the storage unit 13. The constraint information 134 may be updated as appropriate. Examples of the constraint specified by the constraint information 134 will be described later.

The second assignment cost value list 135 is a list including assignment cost values for each of a plurality of tasks by each of a plurality of workers. The second assignment cost value list 135 is a list reflecting the constraint specified by the constraint information 134 to the first assignment cost value list 131. The assignment cost value may also be set to 0. “0” is an example of a value associated with not being assigned with a task and is a minimum value of the assignment cost value. The second assignment cost value list 135 is generated by a modification unit 112 described later. A configuration example of the second assignment cost value list 135 will be described later.

The control unit 11 activates an application program stored in the storage unit 13 to execute the generation unit 111, the modification unit 112, a calculation unit 113, and an output unit 114.

The generation unit 111 generates the first assignment cost value list 131. The modification unit 112 modifies the first assignment cost value list 131 in accordance with a constraint specified by the constraint information 134, to generate the second assignment cost value list 135. The modification includes an intent of change.

The modification unit 112 includes an assignment cost value list acquisition unit 1121, a worker list acquisition unit 1122, a task list acquisition unit 1123, a constraint information acquisition unit 1124, and a constraint reflection unit 1125.

The assignment cost value list acquisition unit 1121 acquires the first assignment cost value list 131.

The worker list acquisition unit 1122 acquires the worker list 132.

The task list acquisition unit 1123 acquires the task list 133.

The constraint information acquisition unit 1124 acquires the constraint information 134.

The constraint reflection unit 1125 generates the second assignment cost value list 135 on the basis of change of one or more assignment cost values configuring the first assignment cost value list 131 in accordance with a constraint specified by the constraint information 134. In a typical example, the constraint reflection unit 1125 identifies, on the basis of the worker list 132, one or more target workers subject to the constraint. The constraint reflection unit 1125 identifies, on the basis of the task list 133, one or more target tasks subject to the constraint. The constraint reflection unit 1125 changes at least any one of one or more assignment cost values associated with the one or more target workers and one or more assignment cost values associated with the one or more target tasks.

The calculation unit 113 uses the second assignment cost value list 135 generated by the modification unit 112 to calculate one or more assignment tables. Each of the assignment tables is data of a table indicating a task assigned to each worker. A configuration example of the assignment table will be described later.

The output unit 114 outputs one assignment table selected from the one or more assignment tables calculated by the calculation unit 113.

A configuration example of the first assignment cost value list 131 will be described.

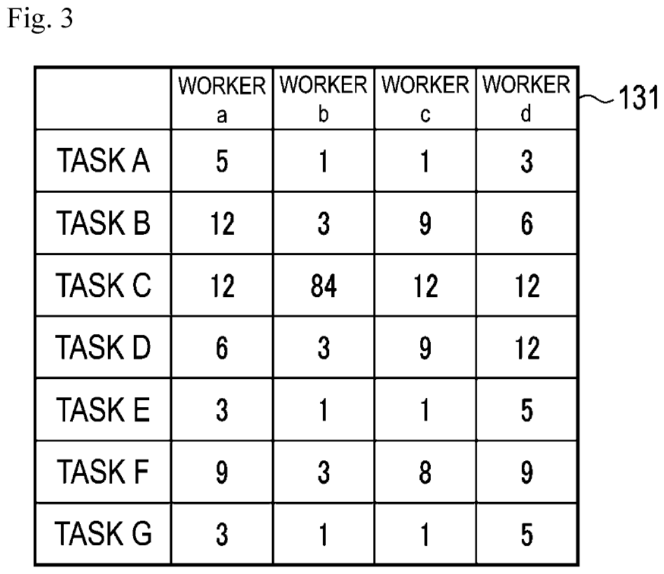

FIG. 3 is a diagram illustrating an example of the first assignment cost value list 131.

The plurality of workers include four workers, that is, a worker a, a worker b, a worker c, and a worker d. The plurality of tasks include seven tasks, that is, a task A, a task B, a task C, a task D, a task E, a task F, and a task G. The first assignment cost value list 131 includes assignment cost values of each of the workers a to d for each of the tasks A to G.

A configuration example of the worker list 132 will be described.

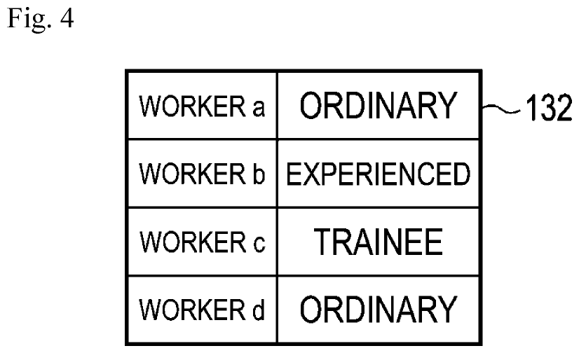

FIG. 4 is a diagram illustrating an example of the worker list 132.

The worker list 132 associates each of the workers a to d with any one of the classifications “trainee,” “ordinary,” and “experienced.”

A configuration example of the task list 133 will be described.

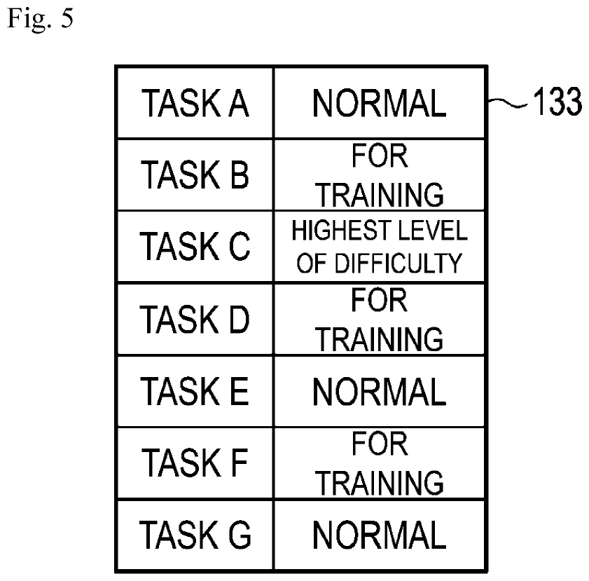

FIG. 5 is a diagram illustrating an example of the task list 133.

The task list 133 associates each of the tasks A to G with any one of the classifications “for training,” “normal,” and “highest level of difficulty.”

### Operation Example

An operation performed by the information processing apparatus 1 configured as described above will be described.

The items and preconditions used to generate the second assignment cost value list 135 will be described.

For example, the items used to generate the second assignment cost value list 135 include the following items.

(1) The number of assignments, which is the number of tasks to be assigned (having a lower limit of “1” and no upper limit)

(2) Assignment cost values configuring the first assignment cost value list 131 (having a lower limit of “1” and no upper limit)

(3) A classification of each worker indicated in the worker list 132

(4) A classification of each task indicated in the task list 133

For example, the preconditions include the following preconditions.

(1) The assignment cost value needs to be an objective function.

(2) There is no person having skills for optimization.

(3) The design is such that it is not possible to manually modify the assignment cost values immediately before the calculation because such a modification involves risks (including, for example, accidentally erasing necessary lines).

(4) A task used for helping a trainee gain experience is classified as “for training.”

(5) There is no task not to be assigned to anyone.

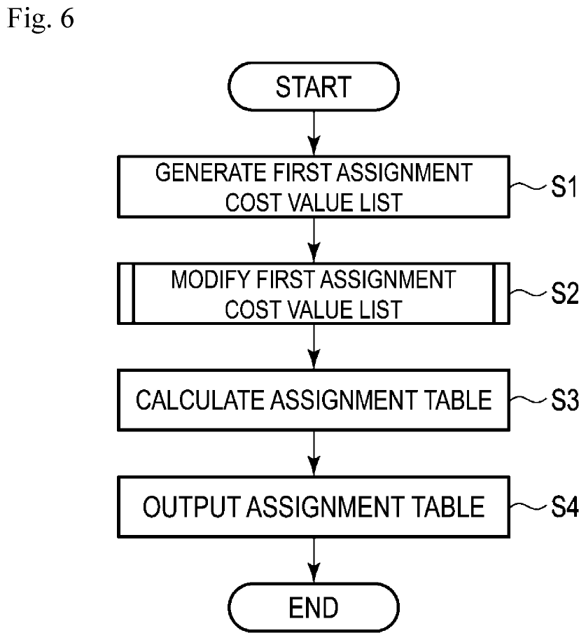

FIG. 6 is a flowchart illustrating a processing procedure and a processing content of processing for calculating an assignment table by the information processing apparatus 1.

The processing procedure described below is merely an example, and each processing may be changed possibly. Furthermore, in the processing procedure described below, steps may be omitted, replaced, and added as appropriate in accordance with the embodiment.

The generation unit 111 generates the first assignment cost value list 131 on the basis of any one or more index values (step S1). In step S1, for example, the generation unit 111 generates the first assignment cost value list 131 on the basis of a generation instruction input through the input apparatus 2 by the assigning person. The generation unit 111 acquires an index value list of any one or more indexes from the input apparatus 2. For example, when the generation unit 111 generates the first assignment cost value list 131 on the basis of one index value, the assignment cost value of each task by each worker may be determined based on any coefficient and values configuring one index value list to generate the first assignment cost value list 131. For example, when the generation unit 111 generates the first assignment cost value list 131 on the basis of two index values, a product of values configuring a list of the two index values may be used as the assignment cost value of each task by each worker to generate the first assignment cost value list 131. For example, the generation unit 111 may add a difficulty level value of each task to a skill value of each task by each worker and use a value obtained by the addition as the quality value for each task by each worker, to generate the first assignment cost value list 131. The generation unit 111 stores the generated first assignment cost value list 131 into the storage unit 13. When the control unit 11 acquires the first assignment cost value list 131 input through the input apparatus 2, the control unit 11 stores the acquired first assignment cost value list 131 into the storage unit 13. In this case, processing of step S1 is omitted.

The modification unit 112 modifies the first assignment cost value list 131 in accordance with a constraint specified by the constraint information 134 to generate the second assignment cost value list 135 (step S2). In step S2, for example, the modification unit 112 generates the first assignment cost value list 131 on the basis of a modification instruction input through the input apparatus 2 by the assigning person. Alternatively, the modification unit 112 may generate the first assignment cost value list 131 on the basis of the generation of the first assignment cost value list 131 by the generation unit 111. The modification unit 112 acquires the first assignment cost value list 131 from the storage unit 13. The modification unit 112 acquires the constraint information 134 from the storage unit 13. The modification unit 112 automatically modifies the first assignment cost value list 131 so as to satisfy a constraint in accordance with the constraint specified by the constraint information 134 to generate the second assignment cost value list 135. An operation example of each unit included in the modification unit 112 will be described later. The modification unit 112 stores, into the storage unit 13, the second assignment cost value list 135 generated in accordance with the modification of the first assignment cost value list 131.

The calculation unit 113 uses the second assignment cost value list 135 generated by the modification unit 112 to calculate one or more assignment tables (step S3). In step S3, for example, the calculation unit 113 generates one or more assignment tables on the basis of a calculation instruction input through the input apparatus 2 by the assigning person. Alternatively, the calculation unit 113 may calculate one or more assignment tables on the basis of the generation of the second assignment cost value list 135 by the modification unit 112. The calculation unit 113 acquires the second assignment cost value list 135 from the storage unit 13. The calculation unit 113 calculates the one or more assignment tables by an optimization calculation for obtaining an optimum solution, using a well-known technique disclosed in PTL 1 and the like, and by using the second assignment cost value list 135. For example, the calculation unit 113 calculates the one or more assignment tables corresponding to the optimum solution by a calculation formula in which an optimum solution is obtained by α distance+β assignment cost value=optimum solution where α and β are weights. There may also be a plurality of combinations of α and β in the same optimum solution. Thus, the calculation unit 113 may also calculate a plurality of different assignment tables in accordance with the combinations of the weights α and β by which the optimum solution is obtained.

The output unit 114 outputs one assignment table selected from the one or more assignment tables calculated by the calculation unit 113 (step S4). In step S4, for example, the output unit 114 outputs an assignment table on the basis of an output instruction input through the input apparatus 2 by the assigning person. Alternatively, the output unit 114 may output the assignment table on the basis of the calculation of the assignment table by the calculation unit 113. The output unit 114 selects, from among the one or more assignment tables calculated by the calculation unit 113, an assignment table corresponding to the optimum solution obtained when both the weights α and β are greater than 0. For example, when the weight β is 0, the optimum solution is a solution having no consideration of the assignment cost value. Thus, the optimum solution in this case is a solution deviating from the real solution. The real solution is a solution in which a task and the like can actually be realized in the real world. That is, the assignment table corresponding to the optimum solution in this case is an assignment table that does not reflect the constraint and cannot actually be used to realize a task and the like in the real world. The output unit 114 outputs the one selected assignment table to the output apparatus 3 via the input and output interface 12. For example, the output apparatus 3 can display the assignment table on a display. The output apparatus 3 can print the assignment table.

A processing example of the above-mentioned step S2 will be described.

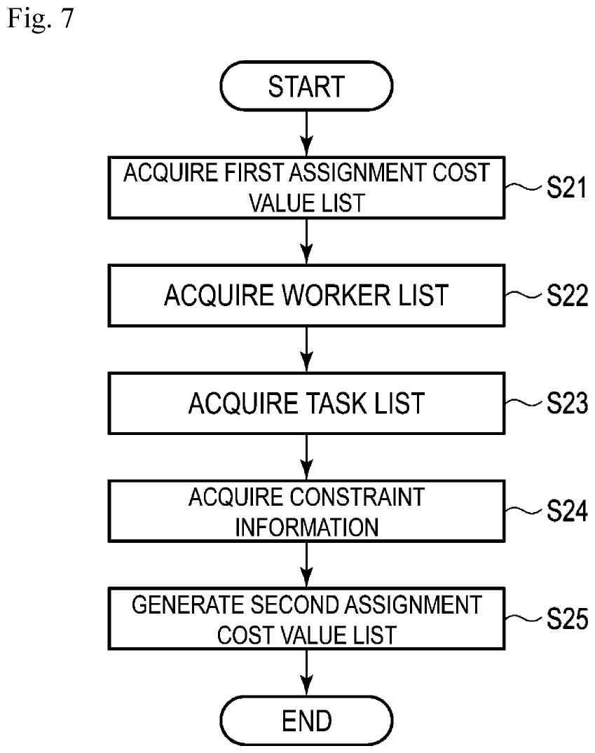

FIG. 7 is a flowchart illustrating a processing procedure and a processing content of modification processing in step S2.

The processing procedure described below is merely an example, and each processing may be changed possibly. Furthermore, in the processing procedure described below, steps may be omitted, replaced, and added as appropriate in accordance with the embodiment.

The assignment cost value list acquisition unit 1121 acquires the first assignment cost value list 131 (step S21). In step S21, for example, the assignment cost value list acquisition unit 1121 acquires the first assignment cost value list 131 from the storage unit 13.

The worker list acquisition unit 1122 acquires the worker list 132 (step S22). In step S21, for example, the worker list acquisition unit 1122 acquires the worker list 132 from the storage unit 13.

The task list acquisition unit 1123 acquires the task list 133 (step S23). In step S23, for example, the task list acquisition unit 1123 acquires the task list 133 from the storage unit 13.

The constraint information acquisition unit 1124 acquires the constraint information 134 (step S23). In step S23, for example, the task list acquisition unit 1123 acquires the task list 133 from the storage unit 13. The constraint information acquisition unit 1124 may acquire the constraint information 134 including one or more constraints selected from a plurality of constraints through the input apparatus 2 by the assigning person.

The constraint reflection unit 1125 generates the second assignment cost value list 135 on the basis of change of one or more assignment cost values configuring the first assignment cost value list 131 in accordance with a constraint specified by the constraint information 134 (step S24). In step S24, for example, the constraint reflection unit 1125 receives the first assignment cost value list 131 acquired by the assignment cost value list acquisition unit 1121. The constraint reflection unit 1125 receives the worker list 132 acquired by the worker list acquisition unit 1122. The constraint reflection unit 1125 receives the task list 133 acquired by the task list acquisition unit 1123. The constraint reflection unit 1125 receives the constraint information 134 acquired by the constraint information acquisition unit 1124. The constraint reflection unit 1125 identifies, on the basis of the worker list 132, one or more target workers subject to a constraint specified by the constraint information 134. The constraint reflection unit 1125 identifies, on the basis of the task list 133, one or more target tasks subject to the constraint. In the first assignment cost value list 131, the constraint reflection unit 1125 changes at least any one of one or more assignment cost values associated with the one or more target workers and one or more assignment cost values associated with the one or more target tasks.

Several examples in which the constraint reflection unit 1125 changes the assignment cost values will be described.

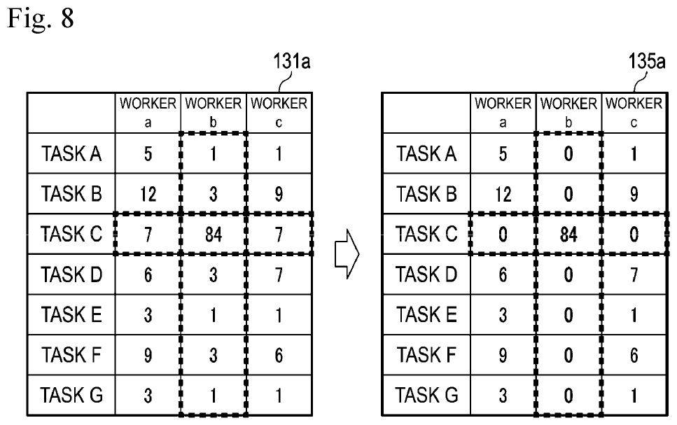

FIG. 8 is a diagram illustrating an example of change of the assignment cost values.

The left side of FIG. 8 shows a first assignment cost value list 131a. The right side of FIG. 8 shows a second assignment cost value list 135a.

When the number of tasks to be assigned is one, it is assumed that the constraint reflection unit 1125 determines that the task C is to be assigned only to the worker b on the basis of a constraint. The task C is a specific target task. The worker b is a specific target worker.

When only the task C is assigned to the worker b on the basis of the constraint, the constraint reflection unit 1125 changes the assignment cost values associated with the tasks A, B, D, E, F, and G other than the task C in the first assignment cost value list 131a to “0” for the worker b. The assignment cost value associated with the task C remains unchanged. Thus, it is possible to prevent a task other than the task C from being assigned to the worker b and increase the possibility that the task C is assigned to the worker b. Furthermore, when only the worker b is assigned to the task C on the basis of the constraint, the constraint reflection unit 1125 changes the assignment cost values associated with the workers a and c other than the worker b in the first assignment cost value list 131a to “0” for the task C. Thus, it is possible to prevent the task C from being assigned to a worker other than the worker b and increase the possibility that the task C is assigned to the worker b. The constraint reflection unit 1125 can create the second assignment cost value list 135a reflecting the constraint.

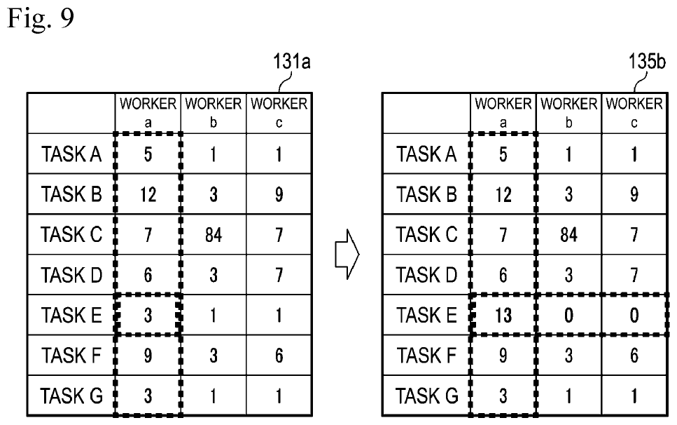

FIG. 9 is a diagram illustrating an example of change of the assignment cost values. The left side of FIG. 9 shows the first assignment cost value list 131a. The right side of FIG. 9 shows a second assignment cost value list 135b.

When a plurality of tasks are to be assigned, it is assumed that the constraint reflection unit 1125 determines that the task E is to be assigned only to the worker a on the basis of a constraint. The task E is a specific target task. The worker a is a specific target worker.

When the task E is assigned to the worker a on the basis of the constraint, the constraint reflection unit 1125 changes the assignment cost value associated with the task E for the worker a to a value greater than the assignment cost values associated with the tasks A, B, C, D, F, and G other than the task E in the first assignment cost value list 131a. The constraint reflection unit 1125 changes the assignment cost value “3” associated with the task E for the worker a to a value of “13” greater than the assignment cost value “12” associated with the task C having the highest value among the tasks A, B, C, D, F, and G. The constraint reflection unit 1125 may change the assignment cost value “3” associated with the task E for the worker a to a value greater than “13.” This makes it possible to increase the possibility that at least the task E is assigned to the worker a. Furthermore, when only the worker a is assigned to the task E on the basis of the constraint, the constraint reflection unit 1125 changes the assignment cost values associated with the workers b and c other than the worker a to “0” for the task E in the first assignment cost value list 131a. Thus, it is possible to prevent the task E from being assigned to a worker other than the worker a and increase the possibility that the task E is assigned to the worker b. The constraint reflection unit 1125 can create the second assignment cost value list 135b reflecting the constraint.

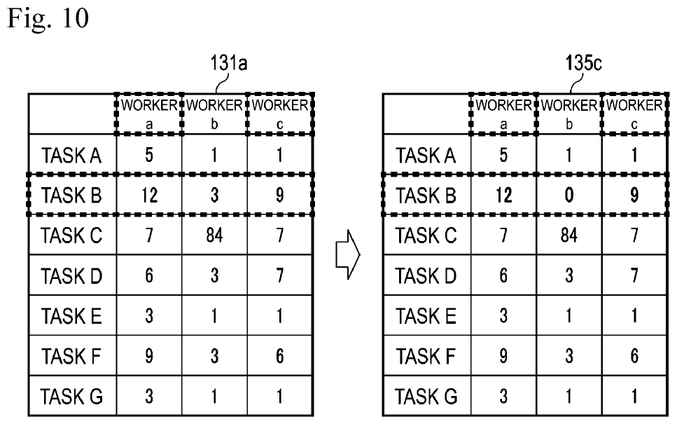

FIG. 10 is a diagram illustrating an example of change of the assignment cost values. The left side of FIG. 10 shows the first assignment cost value list 131a. The right side of FIG. 10 shows a second assignment cost value list 135c.

It is assumed that the constraint reflection unit 1125 determines that the task B is to be assigned only to two workers, the worker a and the worker c on the basis of a constraint. The task B is a specific target task. The worker a and the worker c are specific target workers.

When only the worker a and the worker c are assigned to the task B on the basis of the constraint, the constraint reflection unit 1125 changes the assignment cost value associated with the worker b other than the worker a and the worker c in the first assignment cost value list 131a to “0” for the task B. The assignment cost values associated with the worker a and the worker c for the task B remain unchanged. Thus, it is possible to prevent the task B from being assigned to another worker other than the combination of the worker a and the worker c, and to increase the possibility that the task B is assigned to the two workers, the worker a and the worker c. The constraint reflection unit 1125 can create the second assignment cost value list 135c reflecting the constraint.

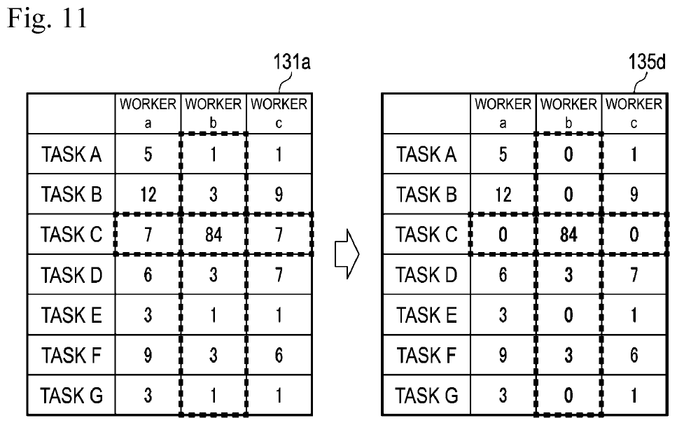

FIG. 11 is a diagram illustrating an example of change of the assignment cost values. The left side of FIG. 11 shows the first assignment cost value list 131a. The right side of FIG. 11 shows a second assignment cost value list 135d.

It is assumed that the constraint reflection unit 1125 determines that the task C is to be assigned only to the worker b, and the task D or the task F is to be assigned to the worker b on the basis of a constraint. The task C is a specific target task. The worker b is a specific target worker.

When the task C is assigned to the worker b, and the task D or the task F is assigned to the worker b on the basis of the constraint, the constraint reflection unit 1125 changes the assignment cost values associated with the tasks A, B, E, and G other than the tasks C, D, and F in the first assignment cost value list 131a to “0” for the worker b. Thus, it is possible to increase the possibility that the task C is assigned to the worker b and the task D or the task F is assigned to the worker b. Furthermore, when only the worker b is assigned to the task C on the basis of the constraint, the constraint reflection unit 1125 changes the assignment cost values associated with the workers a and c other than the worker b in the first assignment cost value list 131a to “0” for the task C. Thus, it is possible to prevent the task C from being assigned to a worker other than the worker b and increase the possibility that the task C is assigned to the worker b. The constraint reflection unit 1125 can create the second assignment cost value list 135d reflecting the constraint.

Next, several examples of constraints will be used to describe examples in which the constraint reflection unit 1125 changes the assignment cost values in accordance with the constraints.

An example of a first constraint will be described.

It is assumed that the first constraint is that “N tasks are to be assigned to a trainee, and the trainee is entrusted with a task for training to train the trainee.”

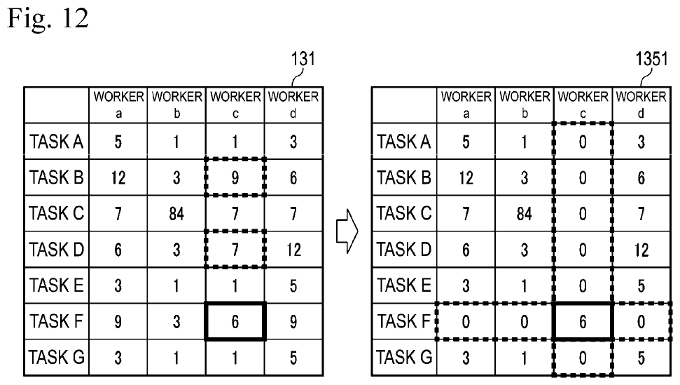

FIG. 12 is a diagram illustrating an example of change of the assignment cost values in accordance with the first constraint.

The left side of FIG. 12 shows the first assignment cost value list 131. The right side of FIG. 12 shows a second assignment cost value list 1351.

The constraint reflection unit 1125 identifies the worker c being a “trainee” as one or more target workers subject to the first constraint on the basis of the worker list 132. When there are a plurality of “trainee” workers, the constraint reflection unit 1125 identifies a plurality of target workers. The constraint reflection unit 1125 identifies the tasks B, D, and F “for training” as one or more target tasks subject to the first constraint on the basis of the task list 133. When there is one task “for training,” the constraint reflection unit 1125 identifies one target task.

The constraint reflection unit 1125 selects N tasks to be assigned from the tasks B, D, and F. For example, the constraint reflection unit 1125 selects N tasks according to any coefficient. For example, any coefficient is used for selecting tasks in the order from a task having the lowest assignment cost value, that is, a task requiring less experience. Here, it is assumed that the number N of tasks to be assigned is 1. The constraint reflection unit 1125 selects the task F having the smallest assignment cost value among the tasks B, D, and F. When the number N of tasks to be assigned is a plural number, the constraint reflection unit 1125 selects a plurality of tasks in the order from a task having the smallest assignment cost value from among the tasks B, D, and F.

It is assumed that the constraint reflection unit 1125 determines that only the task F is to be assigned to the worker c and only the worker c is to be assigned to a worker F on the basis of the first constraint. The worker c is a specific target worker. The task F is a specific target task. When the number N of tasks to be assigned is a plural number, there are a plurality of specific target tasks.

When only the task F is assigned to the worker c on the basis of the first constraint, the constraint reflection unit 1125 changes the assignment cost values associated with the tasks A, B, D, E, F, and G other than the task C in the first assignment cost value list 131 to “0” for the worker c. The assignment cost value associated with the task C remains unchanged. Thus, it is possible to prevent a task other than the task F from being assigned to the worker c and increase the possibility that the task F is assigned to the worker c. Furthermore, when only the worker c is assigned to the task F on the basis of the first constraint, the constraint reflection unit 1125 changes the assignment cost values associated with the workers a, b, and d other than the worker c in the first assignment cost value list 131 to “0” for the task F. Thus, it is possible to prevent the task F from being assigned to a worker other than the worker c and increase the possibility that the task F is assigned to the worker c. The constraint reflection unit 1125 can create the second assignment cost value list 1351 reflecting the first constraint.

An example of a second constraint will be described.

The second constraint is assumed to let a trainee accompany the “ordinary” worker a for N tasks to be assigned to foster the trainee. The trainee is assumed to accompany an ordinary worker and have one task per day in that case.

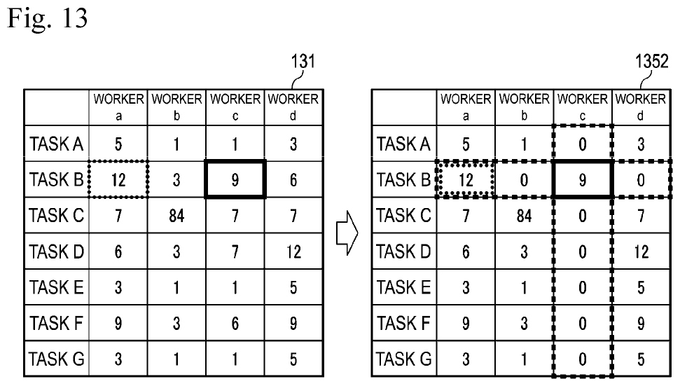

FIG. 13 is a diagram illustrating an example of change of the assignment cost values in accordance with the second constraint.

The left side of FIG. 13 shows the first assignment cost value list 131. The right side of FIG. 13 shows a second assignment cost value list 1352.

The constraint reflection unit 1125 identifies the “ordinary” worker a and the “trainee” worker c as one or more target workers subject to the second constraint on the basis of the worker list 132. The constraint reflection unit 1125 identifies a task that the “ordinary” worker a can perform autonomously on the basis of the task list 133. Here, it is assumed that the “ordinary” worker can autonomously perform a task other than a task having the highest level of difficulty. The constraint reflection unit 1125 identifies the “normal” tasks A, E, and G and the tasks B, D, and F “for training” as one or more target tasks subject to the second constraint on the basis of the task list 133.

The constraint reflection unit 1125 selects one task to accompany the worker c from the tasks A, B, D, E, F, and G. For example, the constraint reflection unit 1125 selects one task according to any coefficient. For example, according to any coefficient, it is possible to use a task having an assignment cost value of “10” or greater for the “ordinary” worker to train the “trainee” worker. The constraint reflection unit 1125 selects the task B having the assignment cost value “12” from the tasks A, B, D, E, F, and G. When there are a plurality of tasks having an assignment cost value of “10” or greater, the constraint reflection unit 1125 may select a task on the basis of any coefficient. For example, any coefficient is used for selecting a task having the highest assignment cost value. It is assumed that the constraint reflection unit 1125 determines that, in order to let the worker c accompany the worker a, only the task B is to be assigned to the worker c on the basis of the second constraint. The worker a and the worker c are specific target workers. The task B is a specific target task.

When only the task B is assigned to the worker c on the basis of the second constraint, the constraint reflection unit 1125 changes the assignment cost values associated with the tasks A, C, D, E, F, and G other than the task B in the first assignment cost value list 131 to “0” for the worker c. The assignment cost value associated with the task C remains unchanged. Thus, it is possible to prevent a task other than the task B from being assigned to the worker c and increase the possibility that the task B is assigned to the worker c. Furthermore, when only the workers a and c are assigned to the task B on the basis of the second constraint, the constraint reflection unit 1125 changes the assignment cost values associated with the workers b and d other than the workers a and c in the first assignment cost value list 131 to “0” for the task B. Thus, it is possible to prevent the task B from being assigned to a worker other than the workers a and c and increase the possibility that the task B is assigned to the workers a and c. The constraint reflection unit 1125 can create the second assignment cost value list 1352 reflecting the second constraint.

An example of a third constraint will be described.

The third constraint is assumed to let a trainee accompany the “ordinary” worker a or the “ordinary” worker d for N tasks to be assigned to train the trainee. The trainee is assumed to accompany an ordinary worker, have one task per day in that case, and accompany for a task in which the trainee lacks experience.

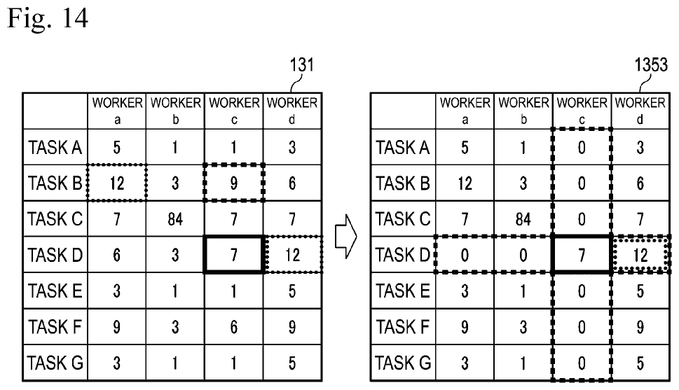

FIG. 14 is a diagram illustrating an example of change of the assignment cost values in accordance with the third constraint.

The left side of FIG. 14 shows the first assignment cost value list 131. The right side of FIG. 14 shows a second assignment cost value list 1353.

The constraint reflection unit 1125 identifies the “ordinary” workers a and d and the “trainee” worker c as one or more target workers subject to the third constraint on the basis of the worker list 132. The constraint reflection unit 1125 identifies a task that the “ordinary” workers a and d can perform autonomously on the basis of the task list 133. Here, it is assumed that the “ordinary” worker can autonomously perform a task other than a task having the highest level of difficulty. The constraint reflection unit 1125 identifies the “normal” tasks A, E, and G and the tasks B, D, and F “for training” as one or more target tasks subject to the third constraint on the basis of the task list 133.

The constraint reflection unit 1125 selects one task to accompany the worker, from the tasks A, B, D, E, F, and G. For example, the constraint reflection unit 1125 selects one task according to any coefficient. For example, according to any coefficient, it is possible to use a task having an assignment cost value of “10” or greater for the “ordinary” worker to train the “trainee” worker. The constraint reflection unit 1125 selects, from the tasks A, B, D, E, F, and G, the task B having the assignment cost value “12” associated with the worker a and the task D having the assignment cost value “12” associated with the worker d. When there are a plurality of tasks having an assignment cost value of “10” or greater, the constraint reflection unit 1125 selects a task according to any coefficient to let the “trainee” worker c accompany for a task in which the trainee lacks experience. For example, selecting a task according to any coefficient is selecting, from a plurality of selected tasks, a task having the lowest assignment cost value associated with the “trainee” worker. The constraint reflection unit 1125 selects the task D having the lowest assignment cost value from among the assignment cost value “9” associated with the task B and the assignment cost value “7” associated with the task D for the worker c. To let the worker c accompany the worker d on the basis of the third constraint, the constraint reflection unit 1125 determines to assign only the task D to the worker c. The worker c and the worker d are specific target workers. The task D is a specific target task.

When only the task D is assigned to the worker c on the basis of the third constraint, the constraint reflection unit 1125 changes the assignment cost values associated with the tasks A, B, C, E, F, and G other than the task D in the first assignment cost value list 131 to “0” for the worker c. The assignment cost value associated with the task D remains unchanged. Thus, it is possible to prevent a task other than the task D from being assigned to the worker c and increase the possibility that the task D is assigned to the worker c. Furthermore, when only the workers c and d are assigned to the task D on the basis of the third constraint, the constraint reflection unit 1125 changes the assignment cost values associated with the workers a and b other than the workers c and d in the first assignment cost value list 131 to “0” for the task D. Thus, it is possible to prevent the task D from being assigned to a worker other than the workers c and d and increase the possibility that the task D is assigned to the workers c and d. The constraint reflection unit 1125 can create the second assignment cost value list 1353 reflecting the third constraint.

An example of a fourth constraint will be described.

The fourth constraint is that “a task having the highest level of difficulty is entrusted only to an experienced worker and the number of tasks assigned to the experienced worker entrusted with the task is one.”

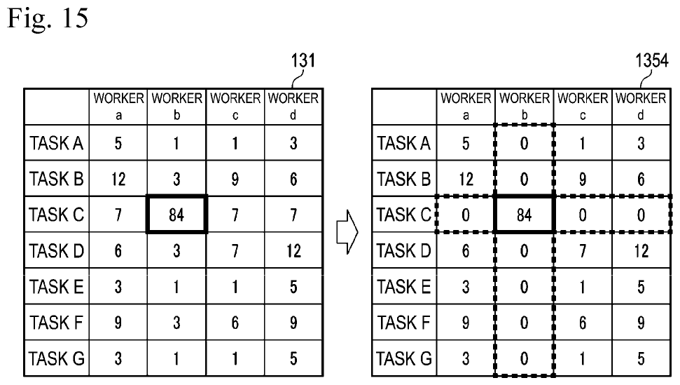

FIG. 15 is a diagram illustrating an example of change of the assignment cost values in accordance with the fourth constraint.

The left side of FIG. 15 shows the first assignment cost value list 131. The right side of FIG. 15 shows a second assignment cost value list 1354.

The constraint reflection unit 1125 identifies the “experienced” worker b as one or more target workers subject to the fourth constraint on the basis of the worker list 132. When there are a plurality of “experienced” workers, the constraint reflection unit 1125 identifies a plurality of target workers. The constraint reflection unit 1125 identifies the task C having the “highest level of difficulty” as one or more target tasks subject to the fourth constraint on the basis of the task list 133. When there are a plurality of tasks having the “highest level of difficulty,” the constraint reflection unit 1125 identifies a plurality of target tasks. In this case, the constraint reflection unit 1125 selects, from the plurality of target tasks, the number of tasks corresponding to the number of tasks to be assigned, according to any coefficient.

It is assumed that the constraint reflection unit 1125 determines that only the task C is to be assigned to the worker b and only the worker b is to be assigned to the task C on the basis of the fourth constraint. The worker b is a specific target worker. The task C is a specific target task. When a plurality of tasks are to be assigned, there are a plurality of specific target tasks.

When only the task C is assigned to the worker b on the basis of the fourth constraint, the constraint reflection unit 1125 changes the assignment cost values associated with the tasks A, B, D, E, F, and G other than the task C in the first assignment cost value list 131 to “0” for the worker b. The assignment cost value associated with the task C remains unchanged. Thus, it is possible to prevent a task other than the task C from being assigned to the worker b and increase the possibility that the task C is assigned to the worker b. Furthermore, when only the worker b is assigned to the task C on the basis of the fourth constraint, the constraint reflection unit 1125 changes the assignment cost values associated with the workers a, c, and d other than the worker b in the first assignment cost value list 131 to “0” for the task C. Thus, it is possible to prevent the task C from being assigned to a worker other than the worker b and increase the possibility that the task C is assigned to the worker b. The constraint reflection unit 1125 can create the second assignment cost value list 1354 reflecting the fourth constraint.

An example of a fifth constraint will be described.

The fifth constraint is that “a task that cannot be autonomously performed by one worker, is to be performed by two workers.” It is assumed that, for example, a “normal” task can be assigned to one worker having the assignment cost value of equal to or greater than a predetermined value (which is assumed to be 8 here, for example). When there is no worker having the assignment cost value of equal to or greater than the predetermined value, the “normal” task can be assigned to two workers having the total of the assignment cost values of equal to or greater than the predetermined value.

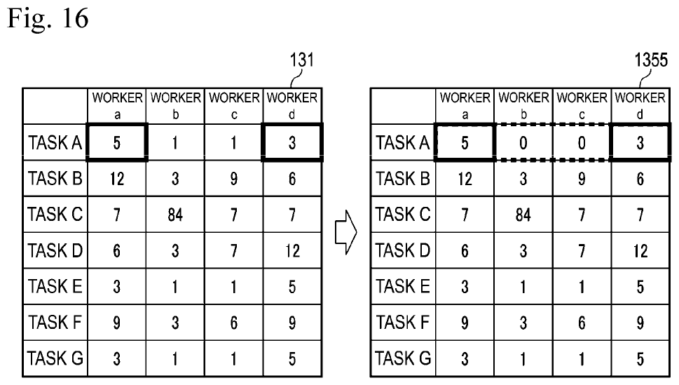

FIG. 16 is a diagram illustrating an example of change of the assignment cost values in accordance with the fifth constraint.

The left side of FIG. 16 shows the first assignment cost value list 131. The right side of FIG. 16 shows a second assignment cost value list 1355.

The constraint reflection unit 1125 determines that all of the assignment cost values associated with each worker for the “normal” tasks A, E, and G are smaller than the predetermined value, 8. The constraint reflection unit 1125 identifies, in accordance with the number of tasks to be performed by two workers, one or more target tasks subject to the fifth constraint on the basis of the task list 133. Here, it is assumed that the constraint reflection unit 1125 identifies one task A as one or more target tasks subject to the fifth constraint on the basis of the task list 133. The constraint reflection unit 1125 may identify a plurality of target tasks.

The constraint reflection unit 1125 identifies a combination in which the total of the assignment cost values is equal to or greater than 8 for the task A. For example, the constraint reflection unit 1125 consecutively adds, to the highest assignment cost value for the task A, another assignment cost value, to identify a combination in which the total of the assignment cost values is equal to or greater than 8. The constraint reflection unit 1125 determines that the total of the assignment cost value of the worker a and the assignment cost value of the worker d for the task A is equal to or greater than 8. Thus, the constraint reflection unit 1125 identifies the workers a and d as one or more target workers subject to the fifth constraint on the basis of the worker list 132.

It is assumed that the constraint reflection unit 1125 determines that the task A is to be assigned only to two workers a and d on the basis of the fifth constraint. The workers a and d are specific target workers. The task A is a specific target task.

When only the workers a and d are assigned to the task A on the basis of the fifth constraint, the constraint reflection unit 1125 changes the assignment cost values associated with the workers b and c other than the workers a and d in the first assignment cost value list 131 to “0” for the task A. Thus, it is possible to prevent the task A from being assigned to a worker other than the workers a and d and increase the possibility that the task A is assigned to the workers a and d. The constraint reflection unit 1125 can create the second assignment cost value list 1355 reflecting the fifth constraint.

Next, an output example of an assignment table will be described.

Here, it is assumed that a second assignment cost value list 1356 reflecting a sixth constraint is used.

The sixth constraint is a constraint including the first constraint and the fourth constraint. The number of tasks to be assigned to a trainee is one.

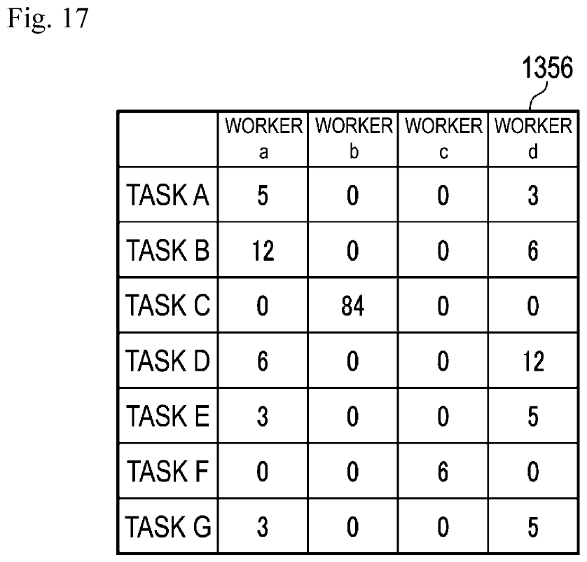

FIG. 17 is a diagram illustrating an example of the second assignment cost value list 1356 reflecting the sixth constraint.

The second assignment cost value list 1356 is an assignment cost value list obtained by reflecting the sixth constraint to the first assignment cost value list 131 by the constraint reflection unit 1125.

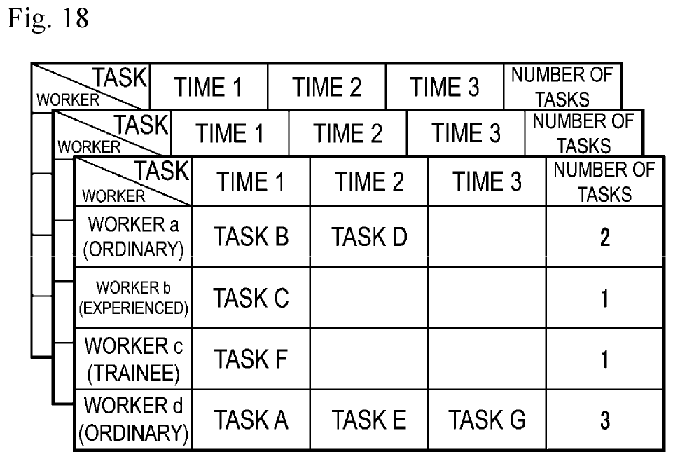

FIG. 18 is a diagram illustrating an example of a plurality of assignment tables calculated by using the second assignment cost value list 1356.

The plurality of assignment tables are calculated using the second assignment cost value list 135 through an optimization calculation by the calculation unit 113. For example, the calculation unit 113 calculates the one or more assignment tables corresponding to the optimum solution by a calculation formula in which an optimum solution is obtained by α distance+β assignment cost value=optimum solution.

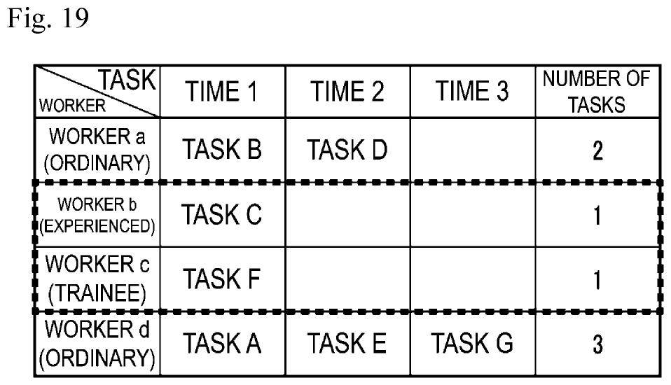

FIG. 19 is a diagram illustrating an example of an output assignment table.

The output unit 114 selects, from among the one or more assignment tables calculated by the calculation unit 113, an assignment table corresponding to the optimum solution obtained when both the weights α and β are greater than 0. The output unit 114 outputs the selected assignment table. In the assignment table shown in FIG. 19, only one task, the task C having the “highest level of difficulty,” is assigned to the “experienced” worker b and only one task, the task F “for training,” is assigned to the “trainee” worker c. Thus, the assignment table reflects the sixth constraint.

An optimum solution obtained when β=0 is satisfied, is a solution having no consideration of the assignment cost value, and thus, is a solution deviating from the real solution. For example, the sixth constraint requires that one task is assigned to a “trainee” worker, but a plurality of tasks may be assigned to the “trainee” worker c.

In a comparative example, a case where the calculation unit 113 calculates the assignment table by using the first assignment cost value list 131 will be described. The assignment table based on the first assignment cost value list 131 deviates from the real solution. For example, each of the workers b and c may be assigned with two tasks. This is because the calculation unit 113 calculates an optimum value by using the total of all assignment cost values.

### Actions and Effects

In the embodiment described above, the information processing apparatus 1 can generate the second assignment cost value list 135 reflecting a constraint on the basis of a change of one or more assignment cost values configuring the first assignment cost value list 131 in accordance with the constraint. In a typical example, the information processing apparatus 1 changes at least any one of one or more assignment cost values associated with one or more target workers and one or more assignment cost values associated with one or more target tasks.

This enables the information processing apparatus 1 to obtain an optimum solution with the constraint reflected, thus achieving realistic assignment of tasks. For example, the information processing apparatus 1 reflects a constraint of a real world problem to the optimization calculation so that an assignment table reflecting the constraint of the real world problem is created, and thus, it is possible to approximate the optimum solution from the optimization calculation to a real solution demanded by the assigning person. As a result, it is possible to reduce a modification operation required for the assignment table by the assigning person. The information processing apparatus 1 may create various designs of assignment tables in accordance with a plurality of constraints to create a design according to a demand of the assigning person. Furthermore, the information processing apparatus 1 may perform an optimization calculation using the second assignment cost value list 135 reflecting the constraint to reduce the amount of data to be prepared in advance. Moreover, it is not necessary to modify the structure of the optimization calculation model (solver), and thus, the information processing apparatus 1 can prevent an increase in the calculation time of the optimization calculation. Furthermore, the information processing apparatus 1 can reduce the variance in the solution from the optimization calculation to increase the calculation speed. Furthermore, even when the information processing apparatus 1 uses different optimization calculation models depending on a change of the characteristics of the assignment cost values, the constraint is reflected to the second assignment cost value list 135, and thus, it is possible to unify a calculation method of the optimization calculation. That is, the assigning person does not need to input a complicated structure to reflect the constraint to the optimization calculation model. Thus, even when the optimization calculation model is a black box, the assigning person can obtain the assignment table reflecting the constraint. There is no need to include a complicated constraint expression into the structure of the optimization calculation model, and thus, no person having skills for optimization is required. It is only required that the assigning person uses the second assignment cost value list 135 reflecting the constraint, and thus, anyone can edit the assignment table.

In the embodiment, when one or more specific target tasks are assigned to a specific target worker on the basis of a constraint, the information processing apparatus 1 changes an assignment cost value associated with one or more tasks other than the one or more specific target tasks to “0” for the specific target worker.

Thus, the information processing apparatus 1 can prevent a task other than the specific target task from being assigned to the specific target worker and can increase the possibility that the specific target task is assigned to the specific target worker.

In the embodiment, when one or more specific target tasks are assigned to a specific target worker on the basis of a constraint, the information processing apparatus 1 changes an assignment cost value of the one or more specific target tasks to a value greater than an assignment cost value associated with one or more tasks other than the one or more specific target tasks for the specific target worker.

Thus, the information processing apparatus 1 can prevent a task other than the specific target task from being assigned to the specific target worker and can increase the possibility that the specific target task is assigned to the specific target worker.

In the embodiment, when one or more specific target workers are assigned to a specific target task on the basis of a constraint, the information processing apparatus 1 changes an assignment cost value associated with one or more workers other than the one or more specific target workers to “0” for the specific target task.

Thus, the information processing apparatus 1 can prevent the specific target task from being assigned to a worker other than the specific target worker and can increase the possibility that the specific target task is assigned to the specific target worker.

In short, the present disclosure is not limited to the aforementioned embodiment and can be variously modified in the implementation stage without departing from the gist of the present disclosure. Also, the embodiments may appropriately be performed in combination as much as possible, and in such a case, combined effects can be obtained. Further, the above embodiment includes the disclosures in various stages, and various disclosures can be extracted from appropriate combinations of a plurality of disclosed components.

The information processing apparatus according to the embodiment can be also implemented by a computer and a program, and the program can be recorded in a recording medium or provided through a network. For example, a scheme described in the embodiment may be stored, as a program (software) executable by a calculator (a computer), in a recording medium, such as a magnetic disk (a hard disk and the like), an optical disk (a CD-ROM, a DVD, and the like), and a semiconductor memory (a ROM, a RAM, a flash memory, and the like) or transferred and distributed by a communication medium. The program stored in the medium also includes a setting program for configuring, in the calculator, software (including not only an execution program, but also a table and a data structure) to be executed by the calculator. A calculator implementing the present apparatus reads the program recorded in the recording medium or, in some cases, constructs software by using the setting program and controls an operation by using the software, to execute the above-described processing. The recording medium referred to the present description is not limited to a recording medium for distribution, and includes a storage medium, such as a magnetic disk or a semiconductor memory provided inside the calculator or in a device connected via a network.

### REFERENCE SIGNS LIST

1 Information processing apparatus

2 Input apparatus

3 Output apparatus

11 Control unit

12 Input and output I/F

13 Storage unit

131 First assignment cost value list

131a First assignment cost value list

132 Worker List

133 Task list

134 Constraint information

135 Second assignment cost value list

135a to 135d Second assignment cost value list

111 Generation unit

112 Modification unit

113 Calculation unit

114 Output unit

1121 Assignment cost value list acquisition unit

1122 Worker list acquisition unit

1123 Task list acquisition unit

1124 Constraint information acquisition unit

1125 Constraint reflection unit

1351 to 1356 Second assignment cost value list

1. An information processing apparatus, comprising a processor configured to perform operations comprising:
acquiring a first assignment cost value list including an assignment cost value of an individual worker of a plurality of workers for an individual task of a plurality of tasks;
acquiring information indicating a constraint for an assignment of the individual task; and
generating a second assignment cost value list in accordance with a change of one or more of the assignment cost values including the first assignment cost value list in accordance with the constraint.

2. The information processing apparatus according to claim 1, the operations further comprising:
acquiring a worker list indicating a classification of the plurality of workers; and
acquiring a task list indicating a classification of the plurality of tasks,
wherein generating the second assignment cost value list comprising:
identifying one or more target workers subject to the constraint in accordance with the worker list, identifying one or more target tasks subject to the constraint in accordance with the task list, and changing at least one of one or more assignment cost values associated with the one or more target workers or one or more assignment cost values associated with the one or more target tasks.

3. The information processing apparatus according to claim 2, wherein
when one or more specific target tasks of the one or more target tasks are assigned to a specific target worker of the one or more target workers in accordance with the constraint, the processor changes an assignment cost value associated with one or more tasks other than the one or more specific target tasks for the specific target worker to a value associated with no task assigned.

4. The information processing apparatus according to claim 2, wherein
when one or more specific target tasks of the one or more target tasks are assigned to a specific target worker of the one or more target workers in accordance with the constraint, the processor changes an assignment cost value of each of the one or more specific target tasks for the specific target worker to a value greater than an assignment cost value associated with one or more tasks other than the one or more specific target tasks.

5. The information processing apparatus according to claim 2, wherein,
when one or more specific target workers of the one or more target workers are assigned to a specific target task of the one or more target tasks in accordance with the constraint, the processor changes an assignment cost value associated with one or more workers other than the one or more specific target workers for the specific target task to a value associated with no task assigned.

6. An information processing method, comprising:
acquiring a first assignment cost value list including an assignment cost value of an individual worker of a plurality of workers for an individual task of a plurality of tasks;
acquiring information indicating a constraint for an assignment of the individual task; and
generating a second assignment cost value list in accordance with a change of one or more of the assignment cost values including the first assignment cost value list in accordance with the constraint.

7. The information processing method according to claim 6, further comprising:
acquiring a worker list indicating a classification of the plurality of workers; and
acquiring a task list indicating a classification of the plurality of tasks, wherein
the generating of the second assignment cost value list includes identifying one or more target workers subject to the constraint in accordance with the worker list, identifying one or more target tasks subject to the constraint in accordance with the task list, and changing at least one of one or more assignment cost values associated with the one or more target workers or one or more assignment cost values associated with the one or more target tasks.

8. (canceled)

9. A non-transitory computer-readable medium storing program instructions that cause a computer to perform operations comprising:
acquiring a first assignment cost value list including an assignment cost value of an individual worker of a plurality of workers for an individual task of a plurality of tasks;
acquiring information indicating a constraint for an assignment of the individual task; and
generating a second assignment cost value list in accordance with a change of one or more of the assignment cost values including the first assignment cost value list in accordance with the constraint.
